(19) United States
(12) Patent Application Publication
(10) Pub. No.: US 2015/0096658 A1
(43) Pub. Date: Apr. 9, 2015

(54) TIRE COMPRISING A WIDENED TREAD

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: Philippe Johnson, Clermont-Ferrand (FR); Julien Metzger, Clermont-Ferrand (FR); Sébastien Noel, Clermont-Ferrand (FR)

(73) Assignees: MICHELIN RECHERCHE ET TECHNIQUE, S.A., Granges-Paccot (CH); COMPAGNIE GENERALE DES ETABLISSEMENTS MICHELIN, Clermont-Ferrand (FR)

(21) Appl. No.: 14/390,830

(22) PCT Filed: Apr. 2, 2013
(86) PCT No.: PCT/EP2013/056911

§ 371 Date: Oct. 6, 2014

(30) Foreign Application Priority Data
Apr. 6, 2012 (FR) 1253195

(51) Int. Cl. B60C 9/00; B60C 1/00; B60C 9/06

(52) U.S. Cl. CPC B60C 9/0007; B60C 9/06; B60C 1/0041
USPC 152/556

(57) ABSTRACT

A tire with a radial carcass reinforcement, wherein the ratio of the axial width L of the tread to the maximum axial width S of the tire is strictly greater than 0.85 and the reinforcing elements of at least one layer of the carcass reinforcement are non-wrapped metal cords with saturated layers, at least one inner layer being sheathed with a layer made up of a polymeric composition such as a composition of non-crosslinkable, crosslinkable or crosslinked rubber, preferably based on at least one diene elastomer.

This application is a 371 national phase entry of PCT/EP2013/056911, filed 2 Apr. 2013, which claims benefit of FR 1253195, filed 6 Apr. 2012, the entire contents of which are incorporated herein by reference for all purposes.

### BACKGROUND

1. Field

The present disclosure relates to a tire with a radial carcass reinforcement and more particularly to a tire intended to be fitted to an axle comprising twin wheels for vehicles carrying heavy loads and driving at sustained speed, such as, for example, lorries, tractors, trailers or buses.

2. Description of Related Art

In general, in tires for heavy-duty vehicles, the carcass reinforcement is anchored on each side in the bead region and is surmounted radially by a crown reinforcement made up of at least two superposed layers formed of threads or cords which are parallel within each layer and crossed from one layer to the next, making angles of between 10° and 45° with the circumferential direction. The said working layers forming the working reinforcement may be further covered by at least one layer, called the protective layer, formed by reinforcing elements which are advantageously metallic and extensible and are called elastic. It may also comprise a layer of metal threads or cords having low extensibility, forming an angle in the range from 45° to 90° with the circumferential direction, this ply, called the triangulation ply, being radially located between the carcass reinforcement and the first crown ply, referred to as the working ply, formed by parallel threads or cords lying at angles not exceeding 45° in absolute terms. The triangulation ply forms a triangulated reinforcement with at least the said working ply, this reinforcement having low deformation under the various stresses which it undergoes, the triangulation ply essentially serving to absorb the transverse compressive forces acting on all the reinforcing elements in the crown area of the tire.

In the case of tires for “heavy-duty” vehicles, just one protective layer is usually present and its protective elements are, in the majority of cases, oriented in the same direction and with the same angle in absolute value as those of the reinforcing elements of the radially outermost and thus radially adjacent working layer. In the case of construction plant tires intended for running on more or less undulating ground, the presence of two protective layers is advantageous, the reinforcing elements being crossed from one layer to the following layer and the reinforcing elements of the radially internal protective layer being crossed with the inextensible reinforcing elements of the radially external working layer adjacent to the said radially internal protective layer.

Radially on the outside of the crown reinforcement is the tread usually made up of polymeric materials intended to come into contact with the ground in the contact patch in which the tire makes contact with the ground.

Cords are said to be inextensible when the said cords, under a tensile force equal to 10% of the breaking force, exhibit a relative elongation of at most 0.2%.

Cords are called elastic if the said cords have a relative elongation of at least 3% under a tensile force equal to the breaking force, with a maximum tangent modulus of less than 150 GPa.

The circumferential direction of the tire, or longitudinal direction, is the direction corresponding to the periphery of the tire and defined by the direction in which the tire runs.

The axis of rotation of the tire is the axis about which it turns in normal use.

A radial or meridian plane is a plane containing the axis of rotation of the tire.

The circumferential mid-plane, or equatorial plane, is a plane which is perpendicular to the axis of rotation of the tire and divides the tire into two halves.

The transverse or axial direction of the tire is parallel to the axis of rotation of the tire. An axial distance is measured in the axial direction. The expression “axially on the inside of or axially on the outside of” respectively means “of which the axial distance, measured from the equatorial plane, is respectively less than or greater than”.

The radial direction is a direction that intersects the axis of rotation of the tire and is perpendicular thereto. A radial distance is measured in the radial direction. The expression “radially on the inside of and radially on the outside of” respectively means “of which the radial distance, measured from the axis of rotation of the tire, is respectively less than or greater than”.

Certain present-day tires, referred to as “road tires”, are intended to run at high speed and over increasingly long journeys, because of the improvements to the road network and the growth of motorway networks worldwide. Unquestionably, the set of conditions in which a tire of this type is required to run enables the distance covered to be increased, as tire wear is lower; however, the endurance of the tire, and particularly that of the crown reinforcement, is adversely affected.

This is because stresses are present at the position of the crown reinforcement; more particularly, there are shear stresses between the crown layers, combined with a non-negligible rise in the operating temperature at the ends of the axially shortest crown layer, resulting in the appearance and propagation of cracks in the rubber at the said ends. This problem exists in the case of edges of two layers of reinforcing elements, the said layers not necessarily being radially adjacent.

In order to limit excessive temperature increases in the crown of the tire, the materials of which the tread is made are advantageously chosen to have hysteresis losses suited to the operating conditions of the tire.

Moreover, in order to improve the endurance of the crown reinforcement of the type of tire being studied, solutions relating to the structure and quality of the layers and/or profiled elements of rubber blends which are positioned between and/or around the ends of plies and, more particularly, the ends of the axially shortest ply have already been provided.

This improvement in the endurance of the tires means that the possibility of retreading when the tread has worn away can at least be contemplated. Specifically, where there is a desire to retread the tire after the tread has worn away, in order to optimize the use of the new tread, a tire that is to be retreaded must not be in too advanced a state of ageing.

As the endurance properties are thus improved, in order to increase the life of the tires before retreading, the designers of the said tires naturally seek to improve the wearing properties of the tires.

In order to increase the life of the tires, it is common practice to choose polymeric materials of which to make the tread that have improved wear-resistance properties. However, such materials usually penalize the hysteresis properties of the tire and for the reasons listed hereinabove use of such materials is not necessarily optimal as far as endurance properties are concerned.

In the knowledge also that the wear-related life of the tire is dependent on the volume of compound of the polymeric materials of which the wearing tread is made, the inventors have sought to increase this volume.

They first of all demonstrated that increasing the volume of the compound of the polymeric materials of which the tread was made in the radial direction leads to changes in the stiffnesses of the tire which notably counteract the performance of the tire in terms of tire tread wear rate.

They were next able to demonstrate that increasing the volume of the compound of the polymeric materials of which the tread was made in the axial direction has a positive impact on the stiffnesses of the tire and on tire tread wear rate.

Moreover, the use of tires on vehicles of the heavy duty type intended for road use, notably when mounted in a twin configuration on a driven axle or on trailers leads to unwanted use in deflated mode. Specifically, analysis has revealed that tires are often run underinflated without the driver being aware of this. Underinflated tires are thus regularly used covering not-insignificant distances. A tire used in this way undergoes greater deformations than under normal conditions of use and this may lead to a “buckling” type of deformation of the carcass reinforcement cords which deformation is very penalizing especially in terms of ability to withstand stresses associated with inflation pressures.

The tests carried out revealed that this phenomenon of buckling is exacerbated if tire treads are widened in the axial direction.

In order to limit this problem associated with the risk of buckling of the reinforcing elements of the carcass reinforcement, it is possible to use cords which are wrapped with an additional thread surrounding the cord potentially preventing the cord from buckling, the wrapping thread seemingly conferring an effect that opposes buckling and therefore limits excessive flexing of the tire in certain regions. Tires produced in this way, although they exhibit lower risks of damage associated with running under low inflation pressures, do, however, exhibit inferior performance in terms of flexural endurance notably because of the rubbing between the wrapping thread and the external threads of the cord during tire deformations when running under normal conditions of use.

It is still possible to alleviate this problem of the buckling of the cords when running with an underinflated tire by at least locally, in the regions facing the region of the carcass reinforcement likely to buckle, increasing the thickness of the layer of rubber that forms the internal wall of the tire cavity. However an increase, even a local one, in the thickness of the layer of rubber separating the carcass reinforcement from the tire cavity leads to a higher tire cost because the rubber blend of which the internal wall of the tire is made is an extremely expensive material.

### SUMMARY

The inventors therefore set themselves the task of being able to provide tires intended to be fitted to vehicles in a twin setup of which tires the compromise between endurance performance and wearing performance is improved even under conditions of running underinflated, and without an increase in the cost of the tire.

This object has been achieved, according to embodiments of the invention, by a tire with a radial carcass reinforcement comprising a crown reinforcement, itself capped radially by a tread which is connected to two beads via two sidewalls, the ratio of the axial width of the tread to the maximum axial width of the tire being strictly greater than 0.85 and the reinforcing elements of at least one layer of the carcass reinforcement being non-wrapped metal cords with saturated layers, at least one inner layer being sheathed with a layer made up of a polymeric composition such as a composition of non-crosslinkable, crosslinkable or crosslinked rubber, preferably based on at least one diene elastomer.

According to a preferred embodiment of the invention, the aspect ratio H/S is strictly greater than 0.55 and preferably greater than 0.60.

The aspect ratio HS is the ratio of the height H of the tire on the rim to the maximum axial width S of the tire when the latter is mounted on its service rim and inflated to its nominal pressure. The height H is defined as the difference between the maximum radius of the tread and the minimum radius of the bead.

The axial width of the tread is measured between two shoulder ends when the tire is mounted on its service rim and inflated to its nominal pressure.

A shoulder end is defined, in the shoulder region of the tire, by the orthogonal projection onto the exterior surface of the tire of the intersection of the tangents to the surfaces of an axially external end of the tread (top of the tread blocks) on the one hand and of the radially external end of a sidewall on the other.

Cords referred to as “layered” cords or “multilayered” cords are cords made up of a central nucleus and of one or more practically concentric layers of strands or threads arranged around this central nucleus.

For the purposes of embodiments of the invention, a saturated layer of a layered cord is a layer formed by threads in which there does not exist sufficient space to add thereto one or more supplementary threads.

Metal cords with saturated layers, at least one inner layer of which is sheathed with a layer made up of a polymeric composition such as a rubber composition, return a zero flow rate on what is referred to as the permeability test.

The “permeability” test makes it possible to determine the longitudinal permeability to air of the cords tested, by measuring the volume of air passing along a test specimen under constant pressure during a given period of time. The principle of such a test, which is well known to those skilled in the art, is to demonstrate the effectiveness of the treatment of a cord to make it impermeable to air; it has been described for example in standard ASTM D2692-98.

The test is carried out on cords extracted directly, by stripping, from the vulcanized rubber plies which they reinforce, thus penetrated by the cured rubber.

The test is carried out on a 2 cm length of cord, thus coated with its surrounding rubber composition (or coating rubber) in the cured state, in the following way: air is sent to the inlet of the cord, under a pressure of 1 bar, and the volume of air at the outlet is measured using a flow meter (calibrated, for example, from 0 to 500 cm³/min). During the measurement, the sample of cord is immobilized in a compressed airtight seal (for example a seal made of dense foam or of rubber) so that only the amount of air passing along the cord from one end to the other, along its longitudinal axis, is taken into account by the measurement; the airtightness of the airtight seal itself is checked beforehand using a solid rubber test specimen, that is to say one devoid of cord.

The lower the mean air flow rate measured (mean over 10 test specimens), the higher the longitudinal impermeability of the cord. As the measurement is carried out with an accuracy of ±0.2 cm³/min, measured values of less than or equal to 0.2 cm³/min are regarded as zeros; they correspond to a cord which can be described as airtight (completely airtight) along its axis (i.e., in its longitudinal direction).

This permeability test furthermore constitutes a simple means of indirect measurement of the degree of penetration of the cord by a rubber composition. The lower the flow rate measured, the greater the degree of penetration of the cord by the rubber.

Cords which in the test referred to as the permeability test return a flow rate of less than 20 cm3/min have a level of penetration higher than 66%.

Cords which in the test referred to as the permeability test return a flow rate of less than 2 cm3/min have a level of penetration higher than 90%.

The degree of penetration of a cord can also be estimated according to the method described below. In the case of a layered cord, the method consists, in a first step, in removing the outer layer of a sample with a length of between 2 and 4 cm in order to subsequently measure, along a longitudinal direction and along a given axis, the sum of the lengths of rubber mixture with respect to the length of the sample. These measurements of lengths of rubber mixture exclude the spaces not penetrated along this longitudinal axis. These measurements are repeated along three longitudinal axes distributed over the periphery of the sample and are repeated on five samples of cords.

When the cord comprises several layers, the first stage of removal is repeated with the newly outer layer and the measurements of lengths of rubber mixture along longitudinal axes.

A mean of all the ratios of lengths of rubber blend to lengths of sample thus determined is then calculated in order to define the degree of penetration of the cord.

The inventors have been able to demonstrate that a tire thus produced according to an embodiment of the invention which, in comparison with a conventional tire of the same size, combines a greater axial tread width and at least one carcass reinforcement layer made up of non-wrapped metal cords with saturated layers, at least one inner layer being sheathed, allows an improvement in tire endurance when used underinflated, particularly when said tire is in a twin setup, without detracting from the endurance properties thereof when running under normal conditions, the wear-related properties of the said tire moreover being improved.

As explained previously, the widening of the tread in the axial direction allows an improvement to the wearing properties of the tire.

Moreover, the inventors have been able to demonstrate that the non-wrapped metal cords with saturated layers, at least one inner layer being sheathed, in the carcass reinforcement, allow a significant improvement in the endurance properties of the carcass reinforcement when the tire is used under conditions of low inflation, without detracting from the endurance properties thereof when running under normal conditions, and with no production-cost penalty. The inventors interpret these results as being due to the presence of the rubber sheath around at least one layer of the metal cords which sheath allows the said cord to tolerate bending with relatively small radii of curvature without the said cord or the threads of which it is made becoming damaged. The inventors believe that they have demonstrated that the presence of the sheath prevents the said cord from collapsing, i.e. prevents the threads of which the cord is made from parting when the cord is bent with very small radii of curvature and thus prevents the risks of the said threads breaking.

Unlike the solutions mentioned previously which involve limiting the curvature of the cords of the carcass reinforcement of the tire when the tire is used underinflated, an embodiment of the invention prevents the risk of breakage of the threads of which the cord is made, the cord nevertheless undergoing the bending imposed as a result of the low inflation pressure.

In other words, the tire according to embodiments of the invention and, more specifically, the reinforcing elements of the carcass reinforcement thereof, experience the bending imposed by unsuitable inflation of the said tire and the nature of the said reinforcing elements, namely the presence of the sheath of rubber around at least one layer of the metal cords, makes it possible to improve the endurance of the said cords experiencing such bending and therefore improve the endurance of the tire when underinflated.

The rubber composition of which the sheath is formed around at least one inner layer of the said metal cords of at least one layer of the carcass reinforcement, and which may be non-crosslinkable, crosslinkable or crosslinked, is preferably based on at least one diene elastomer.

The expression “composition based on at least one diene elastomer” means, in the known way, that the composition contains predominantly (i.e. in a weight percent greater than 50%) this or these diene elastomers.

It should be noted that the sheath according to an embodiment of the invention extends continuously around the layer that it covers (that is to say that this sheath is continuous in the “orthoradial” direction of the cord which is perpendicular to its radius), so as to form a continuous sleeve having a cross section which is advantageously practically circular.

It should also be noted that the rubber composition of this sheath may be cross-linkable or cross-linked; in other words, it comprises, by definition, a cross-linking system adapted to allow the composition to be cross-linked in the course of its curing (i.e. for it to harden, not melt); thus this rubber composition may be described as non-meltable, because it cannot be melted by heating, regardless of the temperature.

The term “diene” elastomer or rubber denotes, in a known way, an elastomer which is based, partially at least (that is to say, it is a homopolymer or a copolymer), on diene monomers (monomers with two carbon-carbon double bonds, which may or may not be conjugated).

Preferably, the cross-linking system of the rubber sheath is what is known as a vulcanization system, in other words one which is based on sulphur (or a sulphur-donating agent) and a primary vulcanization accelerator. This basic vulcanization system may be supplemented with various known secondary accelerators or vulcanization accelerators.

The rubber composition of the sheath according to an embodiment of the invention comprises, in addition to the said crosslinking system, all the customary ingredients that can be used in rubber compositions for tires, such as reinforcing fillers based on carbon black and/or on a reinforcing inorganic filler such as silica, anti-ageing agents, for example antioxidants, extending oils, plasticizers or processability agents that make the compositions easier to work in the raw state, acceptors and donors of methylene, resins, bismaleimides, known adhesion-promoting systems of the “RFS” (resorcinol-formaldehyde-silica) type or metal salts, notably cobalt salts.

Preferably, the composition of this sheath is chosen to be identical to the composition used for the rubber matrix which the cords according to embodiments of the invention are intended to reinforce. Thus, there is no problem of possible incompatibility between the respective materials of the sheath and of the rubber matrix.

According to one alternative form of the invention, the metal reinforcing elements of at least one layer of the carcass reinforcement are layered metal cords of [L+M] or [L+M+N] construction that can be used as reinforcing element in a tire carcass reinforcement, comprising a first layer C1 of L threads of diameter d₁ with L ranging from 1 to 4, surrounded by at least one intermediate layer C2 of M threads of diameter d₂ wound together in a helix at a pitch p₂ with M ranging from 3 to 12, the said layer C2 possibly being surrounded by an outer layer C3 of N threads of diameter d₃ wound together in a helix at a pitch p₃ with N ranging from 8 to 20, and a sheath made up of a non-crosslinkable, crosslinkable or crosslinked rubber composition based on at least one diene elastomer covering the said first layer C1 in the [L+M] construction and at least the said layer C2 in the [L+M+N] construction.

Preferably, the diameter of the threads of the first layer of the inner layer (C1) is between 0.10 and 0.5 mm and the diameter of the threads of the outer layers (C2, C3) is between 0.10 and 0.5 mm.

Preferably too, the helical pitch at which the said threads of the outer layer (C3) are wound is between 8 and 25 mm.

Within the meaning of embodiments of the invention, the helical pitch represents the length, measured parallel to the axis of the cord, at the end of which a thread that has this pitch makes a complete turn around the axis of the cord; thus, if the axis is sectioned on two planes perpendicular to the said axis and separated by a length equal to the pitch of a thread of a layer of which the cord is made up, the axis of this cord has the same position in these two planes on the two circles that correspond to the layer of the thread considered.

Advantageously, the cord has one, and more preferably still, all, of the following features:

the layer C3 is a saturated layer, that is to say that there does not exist sufficient space in this layer to add thereto at least one (N+1)th thread of diameter d₃, N then representing the maximum number of threads which can be wound as a layer around the layer C2;

the rubber sheath in addition covers the inner layer C1 and/or separates the pairs of adjacent threads of the intermediate layer C2;

the rubber sheath covers virtually the radially inner half-circumference of each thread of the layer C3, so that it separates the adjacent pairs of threads of this layer C3.

Generally, embodiments of the invention can be employed, to form the cords of the carcass reinforcement which are described above, with metal threads of any type, in particular made of steel, for example threads made of carbon steel and/or threads made of stainless steel. Use is preferably made of carbon steel but it is, of course, possible to use other steels or other alloys.

When a carbon steel is used, its carbon content (% by weight of steel) is preferably between 0.1% and 1.2%, more preferably between 0.4% and 1.0%; these contents represent a good compromise between the mechanical properties required for the tire and the feasibility of the thread. It should be noted that a carbon content of between 0.5% and 0.6% renders such steels finally less expensive as they are easier to draw. Another advantageous embodiment of the invention can also consist, depending on the applications targeted, in using steels having a low carbon content, for example of between 0.2% and 0.5%, due in particular to a lower cost and to a greater ease of drawing.

The cord according to an embodiment of the invention can be obtained according to various techniques known to a person skilled in the art, for example in two stages, first of all by sheathing the core or intermediate L+M structure (layers C1+C2) via an extrusion head, which stage is followed, in a second step, by a final operation in which the N remaining threads (layer C3) are cabled or twisted around the layer C2 thus sheathed. The problem of tack in the raw state posed by the rubber sheath during any intermediate winding and unwinding operations that might be employed, can be solved in a way known to a person skilled in the art, for example by the use of an interposed plastic film.

According to one embodiment of the invention, the crown reinforcement of the tire is formed of at least two working crown layers of inextensible reinforcing elements, crossed from one layer to the other, forming, with the circumferential direction, angles of between 10° and 45°.

According to other embodiments of the invention, the crown reinforcement further comprises at least one layer of circumferential reinforcing elements.

One embodiment of the invention also makes provision that the crown reinforcement is supplemented radially on the outside by at least one additional layer referred to as a protective layer, of reinforcing elements called elastic, oriented with respect to the circumferential direction at an angle of between 10° and 45° and in the same direction as the angle formed by the inextensible elements of the working layer radially adjacent to it.

According to any one of the embodiments of the invention mentioned hereinabove, the crown reinforcement may further be supplemented, radially on the inside between the carcass reinforcement and the radially internal working layer closest to the said carcass reinforcement, by a triangulation layer of inextensible metal reinforcing elements made of steel forming with the circumferential direction an angle greater than 60° and in the same direction as the direction of the angle formed by the reinforcing elements of the radially closest layer of the carcass reinforcement.

### BRIEF DESCRIPTION OF DRAWINGS

Other details and advantageous features of embodiments of the invention will become apparent hereinafter from the description of some exemplary embodiments of the invention given with reference to FIGS. 1 to 5 which depict:

FIG. 1: a meridian schematic view of a tire according to an embodiment of the invention,

FIG. 2: a meridian schematic view of part of the tire of FIG. 1, to illustrate how a shoulder end is determined,

FIG. 3: a schematic depiction of a cross section of a first example of a carcass reinforcing cord of the tire of FIG. 1,

FIG. 4: a schematic depiction of a cross section of a second example of a carcass reinforcing cord according to the invention,

FIG. 5: a schematic depiction of a view in cross section of a third example of a carcass reinforcing cord according to the invention.

In order make them easier to understand, the figures have not been drawn to scale.

### DETAILED DESCRIPTION OF SPECIFIC EMBODIMENTS

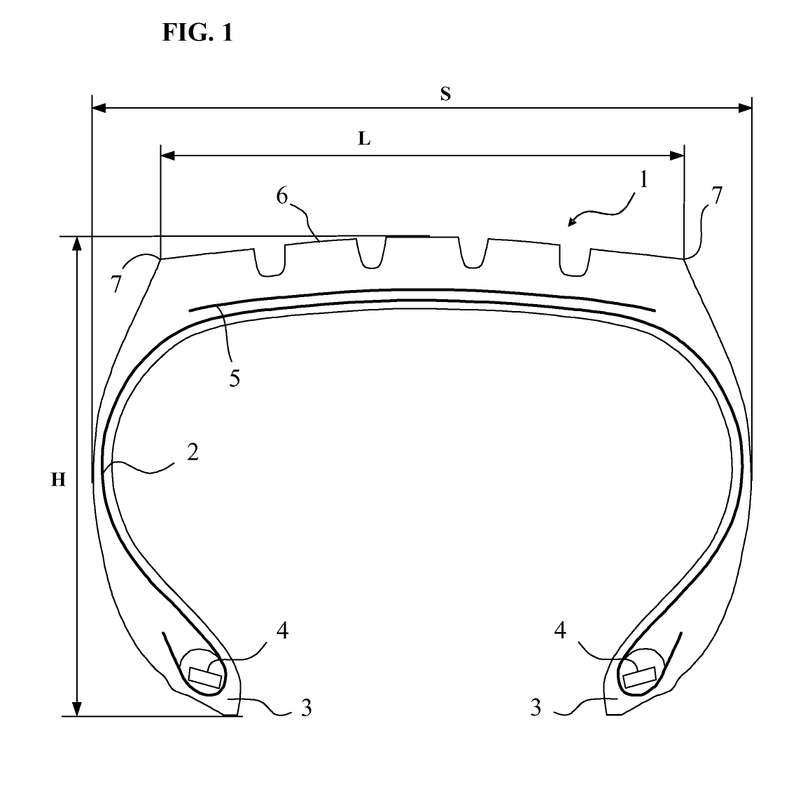

In FIG. 1, the tire 1, of size 315/80 R 22.5 has an aspect ratio H/S equal to 0.80, H being the height of the tire 1 on its mounting rim and S its maximum axial width. The said tire comprises a radial carcass reinforcement 2 anchored in two beads 3 around bead wires 4. The carcass reinforcement 2 is formed of a single layer of metal cords. The carcass reinforcement 2 is wrapped by a crown reinforcement 5, itself capped by a tread 6.

The crown reinforcement 5 is formed radially from the inside to the outside:
of a triangulation layer formed of nonwrapped inextensible 9.35 metal cords which are continuous across the entire width of the ply and oriented at an angle of 65°,
of a first working layer formed of non-wrapped inextensible 11.35 metal cords which are continuous across the entire width of the ply, oriented at an angle of 18°,
of a second working layer formed of non-wrapped inextensible 11.35 metal cords which are continuous across the entire width of the ply, oriented at an angle of 18° and crossed with the metal cords of the first working layer,
of a protective layer formed of non-wrapped elastic 6.35 metal cords which are continuous across the entire width of the ply, oriented at an angle of 18° in the same direction as the metal cords of the second working layer.

Not all of the layers have been depicted in detail in the figures.

The axial width L of the tread of the tire is measured between the two shoulder ends 7. The width L is equal to 275 mm.

According to an embodiment of the invention, the ratio of the axial width L of the tread of the tire 1 to the maximum axial width S thereof is equal to 0.88 and therefore far higher than 0.85.

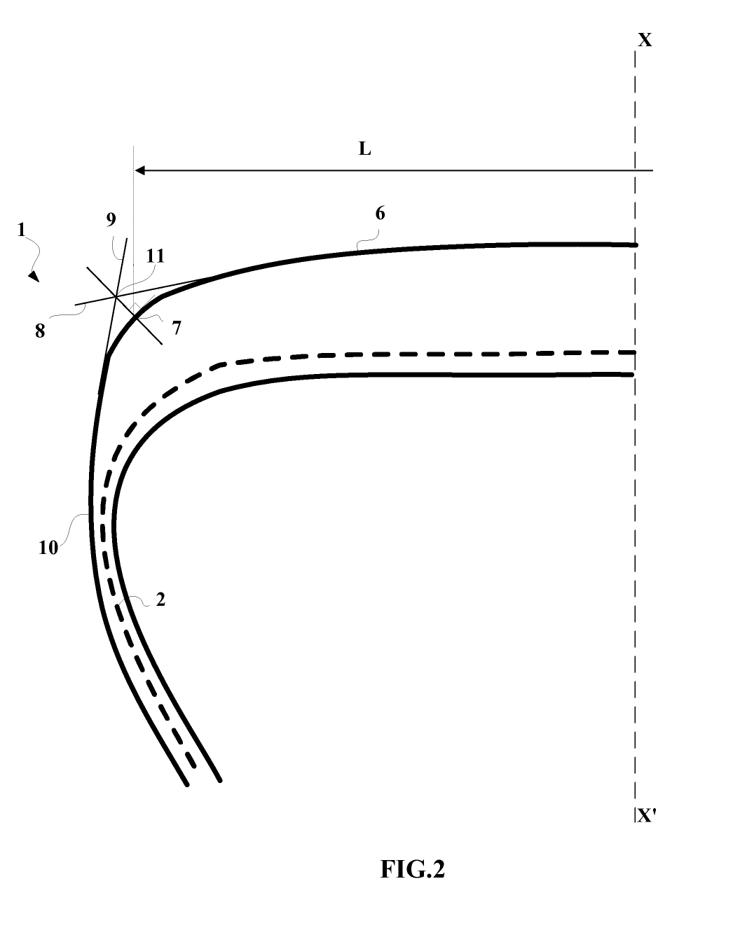

FIG. 2 depicts a partial meridian schematic view of a tire 1 the shoulder ends 7 of which are not as clearly apparent here as they are in the diagram of FIG. 1. FIG. 2 notably depicts just half a view of a tire which continues symmetrically about the axis XX′ which represents the circumferential mid-plane or equatorial plane of a tire.

FIG. 2 illustrates how the shoulder ends 7 may be determined. FIG. 2 thus shows a first tangent 8 to the surface of an axially outer end of the tread 6; the surface of the tread is defined by the radially external surface or top of the tread blocks. A second tangent 9 to the surface of the radially external end of a sidewall 10 intersects the first tangent 8 at a point 11. The orthogonal projection of this point 11 onto the external surface of the tire defines the shoulder end 7.

FIG. 3 illustrates a schematic depiction of the cross section of a carcass reinforcement cord 31 of the tire 1 of FIG. 1. This cord 31 is a non-wrapped layer cord of 1+6+12 structure made up of a central nucleus formed of one thread 32, of an intermediate layer formed of six threads 33 and of an outer layer formed of twelve threads 35.

It exhibits the following characteristics (d and p in mm):
1+6+12 structure;
d₁=0.20 (mm);
d₂=0.18 (mm);
p₂=10 (mm);
d₃=0.18 (mm);
p₃=10 (mm);
(d₂/d₃)=1;
   with d₂ and p₂ respectively the diameter and the helical pitch of the intermediate layer and d₃ and p₃ respectively the diameter and the helical pitch of the threads of the outer layer.

The core of the cord, composed of the central nucleus formed of the thread 32 and of the intermediate layer formed of the six threads 33, is sheathed with a rubber composition 34 based on unvulcanized diene elastomer (in the raw state). The sheathing is obtained via a head for extrusion of the core composed of the thread 32 surrounded by the six threads 33, followed by a final operation in which the twelve threads 35 are twisted or cabled around the core thus sheathed.

The aptitude for penetration of the cord 31, measured according to the method described above, is equal to 95%.

The elastomeric composition of which the rubber sheath 24 is made is produced from a composition as described hereinabove and in this particular instance has the same formulation, based on natural rubber and carbon black, as the calendering layers 13 of the carcass reinforcement that the cords are intended to reinforce.

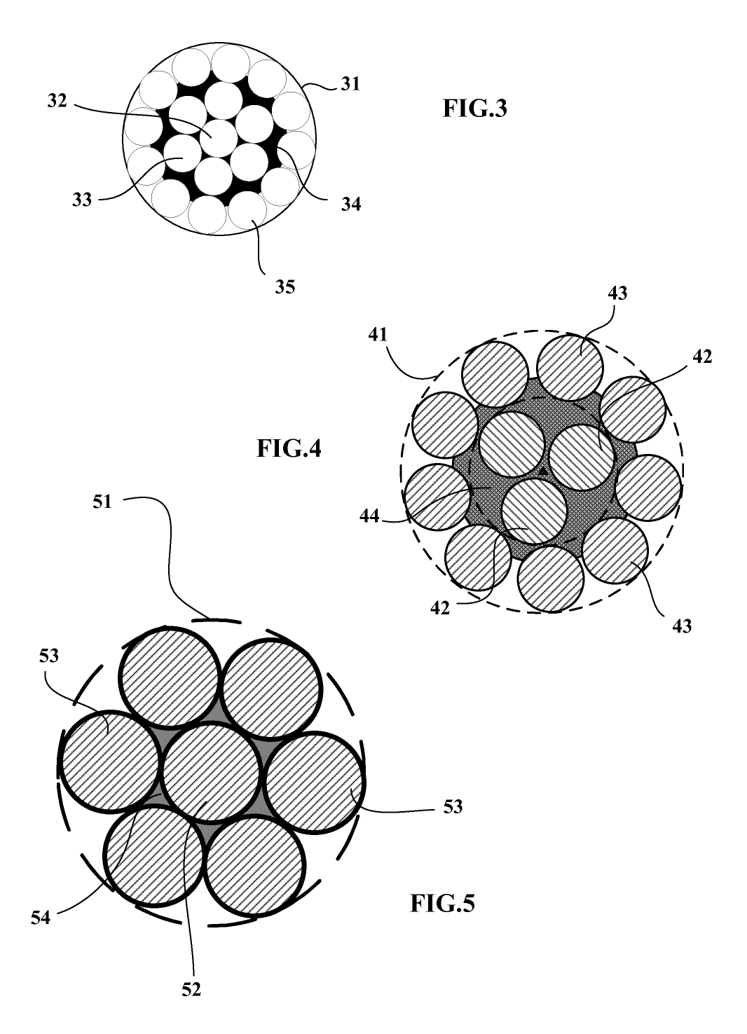

FIG. 4 illustrates a schematic depiction of the cross section of another carcass reinforcement cord 41 which can be used in a tire according to an embodiment of the invention. This cord 41 is a non-wrapped layered cord of 3+9 structure, composed of a central core formed of a cord composed of three threads 42 twisted around one another and of an outer layer formed of nine threads 43.

It exhibits the following characteristics (d and p in mm):
3+9 structure;
d₁=0.18 (mm);
p₂=5 (mm);
(d₁/d₂)=1;
d₂=0.18 (mm);
p₃=10 (mm);
   with d₁ and p1 respectively being the diameter and the helical pitch of the threads of the central core and d₂ and p₂ respectively being the diameter and the helical pitch of the threads of the outer layer.

The central core made up of a cord formed of the three threads 42 has been sheathed with a rubber composition 44 based on unvulcanized diene elastomer (in the raw state). The sheathing is obtained via a head for extrusion of the cord 42, followed by a final operation in which the nine threads 43 are cabled around the core thus sheathed.

The aptitude for penetration of the cord 41, measured according to the method described above, is equal to 95%.

FIG. 5 illustrates a schematic depiction of the cross section of another carcass reinforcement cord 51 which can be used in a tire according to an embodiment of the invention. This cord 51 is a non-wrapped layered cord of 1+6 structure, composed of a central nucleus formed of a thread 52 and of an outer layer formed of six threads 53.

It exhibits the following characteristics (d and p in mm):
1+6 structure;
d₁=0.200 (mm);
(d₁/d₂)=1.14;
d₂=0.175 (mm);
p₂=10 (mm),
   with d₁ the diameter of the nucleus and d₂ and p₂ respectively the diameter and the helical pitch of the threads of the outer layer.

The central nucleus made up of the thread 52 has been sheathed with a rubber composition 54 based on unvulcanized diene elastomer (in the raw state). The sheathing is obtained via a head for extrusion of the thread 52, followed by a final operation in which the six threads 53 are cabled around the nucleus thus sheathed.

The aptitude for penetration of the cord 41, measured according to the method described above, is equal to 95%.

Tests have been carried out on tires produced according to an embodiment of the invention in accordance with the depiction of FIGS. 1 and 3 and other tests have been carried out with what is referred to as reference tires.

First reference tires R1, of size 315/80 like the tires according to the embodiment of the invention, differ from the latter in that they have a tread that is not as wide. The width of the tread L of these tires is equal to 261 mm. The ratio of the axial width L of the tread of a tire R1 to the maximum axial width S thereof is equal to 0.83.

The reference tires R1 further differ from the tires according to the embodiment of the invention in that the carcass reinforcing elements do not comprise the sheathing layer 34.

The second reference tires R2, of size 315/80 like the tires according to the embodiment of the invention, have the same tread width L thereas. The ratio of the axial width L of the tread of a tire R2 to the maximum axial width S thereof is therefore equal to 0.88 as in the case of the tires according to the invention.

The reference tires R2 do, however, differ from the tires according to the embodiment of the invention in that the carcass reinforcing elements do not comprise the sheathing layer 34.

The tests involved reproducing a running of twin tires in which one of the tires was underinflated. To do that, the three types of tire, the tires according to the embodiment of the invention and reference tires R1 and R2, are tested in a twin setup, one inflated to 0.4 bar and therefore to a low pressure and the other to 7 bar. The inflation conditions are strictly the same for all three types of tire.

The tires were run on the vehicle under absolutely identical conditions reproducing the usual type of journey performed by vehicles of the heavy goods type.

Running was regularly interrupted in order to raise the pressure of the tire being tested from 0.4 to 7 bar and then to observe the tires. Running was then resumed at 0.4 bar until the time of the next stop. The test was finished when irreversible damage to the reinforcing elements of the carcass reinforcement was detected.

The reference tires R1 were therefore able to cover a mean distance of 2500 km under the conditions imposed during the test.

Reference tires R2 on the other hand covered a mean distance of 330 km. This result demonstrates the influence that widening the tread has on the stresses experienced by the reinforcing elements in the carcass reinforcement of a tire in an underinflated state.

As far as the tires according to the invention are concerned, they covered a mean distance of 3500 km. Compared with the reference tires R2, it is clearly evident that the nature of the reinforcing elements of the carcass reinforcement, these having a rubber sheath 34 according to the embodiment of the invention, yields tires capable of suffering the negative effects of underinflation while at the same time maintaining their integrity for a far longer period of running

The comparison against the reference tires R2 also shows that the effect caused by the widening of the tread is more than compensated for by the nature of the reinforcing elements of the carcass reinforcement, these having a rubber sheath 34.

The tires according to the embodiment of the invention therefore make it possible to improve the wearing properties compared with tires that have a tread that is not as wide and at the same time improve endurance properties as far as running with the tires underinflated is concerned.

1. A tire with a radial carcass reinforcement comprising a crown reinforcement, itself capped radially by a tread which is connected to two beads via two sidewalls, wherein a ratio of an axial width L of the tread to a maximum axial width S of the tire is greater than 0.85, and wherein reinforcing elements of at least one layer of a carcass reinforcement are non-wrapped metal cords with saturated layers, at least one inner layer being sheathed with a layer made up of a polymeric composition.

2. The tire according to claim 1, wherein the aspect ratio HS is greater than 0.55, wherein H is height of the tire on its mounting rim.

3. The tire according to claim 1, wherein the metal reinforcing elements of at least one layer of the carcass reinforcement are layered metal cords of [L+M] or [L+M+N] construction that can be used as reinforcing element in a tire carcass reinforcement, comprising a first layer C1 of L threads of diameter d1 with L ranging from 1 to 4, surrounded by at least one intermediate layer C2 of M threads of diameter d2 wound together in a helix at a pitch p2 with M ranging from 3 to 12, the said layer C2 possibly being surrounded by an outer layer C3 of N threads of diameter d3 wound together in a helix at a pitch p3 with N ranging from 8 to 20, and wherein a sheath made up of a non-crosslinkable, crosslinkable or crosslinked rubber composition based on at least one diene elastomer covers the said first layer C1 in the [L+M] construction and at least the layer C2 in the [L+M+N] construction.

4. The tire according to claim 3, wherein the threads of the first layer (C1) have a diameter that is between 0.10 and 0.5 mm, and wherein the threads of the layers (C2, C3) have a diameter that is between 0.10 and 0.5 mm.

5. The tire according to claim 3, wherein the helical pitch at which the said threads of the outer layer (C3) are wound is between 8 and 25 mm.

6. The tire according to claim 1, wherein the crown reinforcement is formed of at least two working crown layers of inextensible reinforcing elements, crossed from one layer to the other, forming, with the circumferential direction, angles of between 10° and 45°.

7. The tire according to claim 1, wherein the crown reinforcement further comprises at least one layer of circumferential reinforcing elements.

8. The tire according to claim 1, wherein the crown reinforcement is supplemented radially on the outside by at least one additional ply referred to as a protective ply, of reinforcing elements called elastic, oriented with respect to the circumferential direction at an angle of between 10° and 45° and in the same direction as the angle formed by the inextensible elements of the working ply radially adjacent to it.

9. The tire according to claim 1, wherein the crown reinforcement further includes a triangulation layer formed from metallic reinforcing elements forming angles of more than 60° with the circumferential direction.

10. The tire according to claim 1, wherein the polymeric composition comprises a composition of non-crosslinkable, crosslinkable or crosslinked rubber.

11. The tire according to claim 10, wherein the polymeric composition comprises a composition based on at least one diene elastomer.
